(19) United States
(12) Patent Application Publication
(10) Pub. No.: US 2017/0160625 A1
(43) Pub. Date: Jun. 8, 2017

(54) Camera mounting apparatus using shape-retaining deformable material

(71) Applicant: Mark Kenneth Bright, Lynden, WA (US)

(72) Inventor: Mark Kenneth Bright, Lynden, WA (US)

(21) Appl. No.: 15/371,262

(22) Filed: Dec. 7, 2016

Related U.S. Application Data
(60) Provisional application No. 62/264,322, filed on Dec. 8, 2015.

(51) Int. Cl. G03B 17/56; F16B 47/00; F16M 13/04; F16B 2/26; F16M 13/02; F16M 11/40

(52) U.S. Cl. CPC G03B 17/561; F16M 13/022; F16M 11/40; F16M 13/04; F16B 2/26; F16B 47/00; G03B 17/566

(57) ABSTRACT

The present invention is directed towards a mounting apparatus assembly consisting of a base piece, a device tripod mount and a pair of reusable cable ties. The assembly functions as a mounting apparatus for cameras and phones and allows said devices to mount to a plurality of surfaces and structures. The apparatus is secured to the surfaces and structures by the shape retaining reusable cable ties. The reusable cable ties can be deformed into any position and retain their shape. The base piece has five through-holes. Two mounting holes run through one edge of the base piece and two mounting holes run through the opposing edge. A smaller hole runs through the center of the base piece.

One cable is passed through the two mounting holes on one edge (first and second hole) of the base piece and the other cable is passed through the two mounting holes on the opposing edge (third and fourth hole). A tripod screw is inserted through the center hole (fifth hole) and screws into a plurality of commercially available device mounts. In some embodiments, a suction cup is affixed to the end of one or more cables to allow the mounting apparatus to mount to a vertical flat surface.

### CROSS-REFERENCE TO RELATED APPLICATIONS

Related to provisional patent application No. 62/264,322

### BACKGROUND

1. Field of the Invention

The present invention relates to a mounting apparatus using shape-retaining deformable material to mount devices including cameras and phones on a plurality of structural members and surfaces of various objects and to also function as a four-legged camera stand (quadpod). The shape-retaining material is embodied in the form of a reusable twist tie (U.S. classification 24/30.5T) that is twisted around a structural member to securely mount a camera device.

2. Description of the Related Art

Typical device mounts use hardware consisting of clamps and screws to mount cameras and phones to various surfaces and structural members. Such mounts are designed for use on structures of a specific size, and as such they are not universal in nature and cannot easily be adapted to fit different sized structural members.

Some device mounts utilize flexible shape-retaining material or ball and socket joint connectors (U.S. classification 403/56) to mount devices to structural members. Such mounts are limited in the manner in which they support devices because they cannot mount securely on a wide range of different sized structural members. For example, a single mount cannot securely fit on a 0.5 inch diameter post and also a 12 inch diameter post because the size variance is too great and cannot be accommodated by the design characteristics of the said mounts.

What is called for is a compact mounting apparatus that may function as a four-legged camera stand and also as a camera mount that grips and mounts securely to structural members of a wide range of sizes, including structural members exceeding 12 inches in diameter.

### BRIEF SUMMARY OF THE INVENTION

The present invention is directed towards a mounting apparatus assembly consisting of a base piece, a tripod screw, a commercially available electronic device tripod mount and a pair of commercially available shape retaining reusable cable ties. The assembly functions as a mounting apparatus for cameras and phones and allows said devices to mount to a plurality of surfaces and structures. The apparatus is secured to the surfaces and structures by the shape retaining reusable cable ties. The reusable cable ties can be deformed into any position and retain their shape and they are wrapped in a textured outer covering to help create a secure grip with a mounting surface. The base piece has five mounting through-holes. Two mounting holes run through one edge of the base piece and two mounting holes run through the opposing edge. A smaller hole runs through the center of the base piece.

One cable is passed through the two mounting holes on one edge (first and second hole) of the base piece and the other cable is passed through the two mounting holes on the opposing edge (third and fourth hole). A tripod screw is inserted through the center hole (fifth hole) and screws into a plurality of commercially available device tripod mounts. In some embodiments, a self-closing slot suction cup is affixed to the end of one or more cables to allow the mounting apparatus to mount to a vertical flat surface such as a window.

### BRIEF DESCRIPTION OF THE DRAWINGS

FIG. 1 is an exploded perspective view, showing the various components that make up the invention.

FIG. 2 is a downward looking perspective view, showing how the cables pass through the four holes in the base piece.

FIG. 3 is an upward looking perspective view, showing the tripod screw traveling through the center hole in the base piece and connecting to the tripod mount on the opposite side of the base piece.

FIG. 4 is an upward looking perspective view of the base piece only, showing a circular recessed area around the center hole which allows the tripod screw, when installed, to sit flush with the bottom of the base piece.

FIG. 5 shows the invention mounted to a standard street light structure.

FIG. 6 shows another embodiment of the invention mounted to a flat glass surface.

FIG. 7 shows the invention mounted to a paddle.

FIG. 8 shows how the cable ties are twisted around the shaft of a paddle.

FIG. 9 shows another embodiment of the invention where a device tripod mount is integrated into the base piece 2.

FIG. 10 shows the invention used as an adjustable, four-legged camera stand with a phone attached.

FIG. 11 shows the invention used as a head mount for hands free filming.

### DETAILED DESCRIPTION OF THE INVENTION

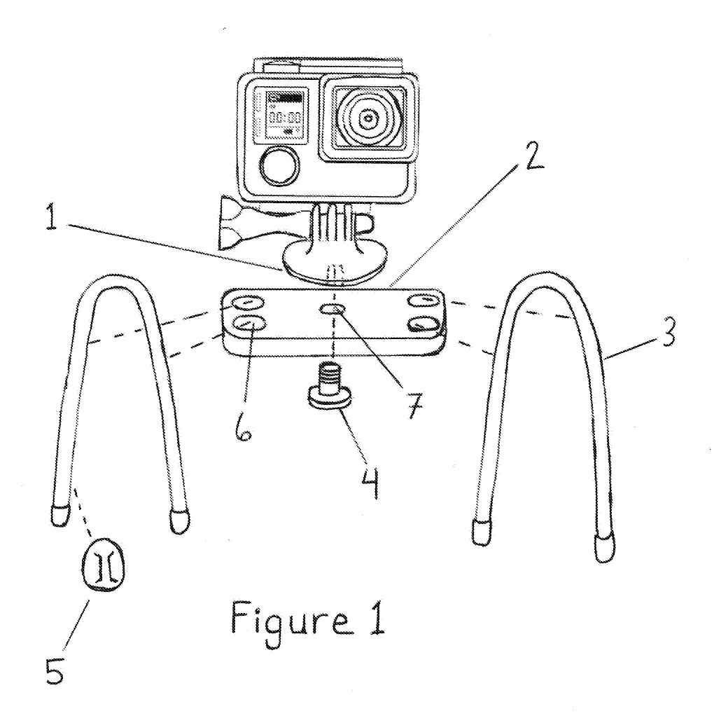

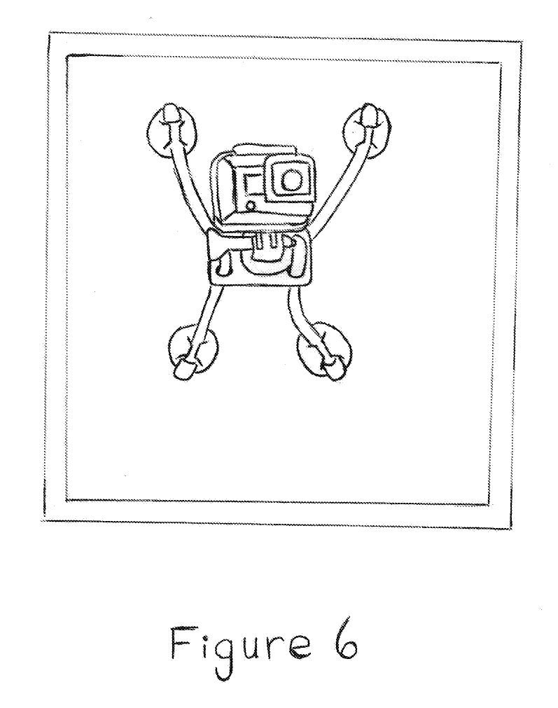

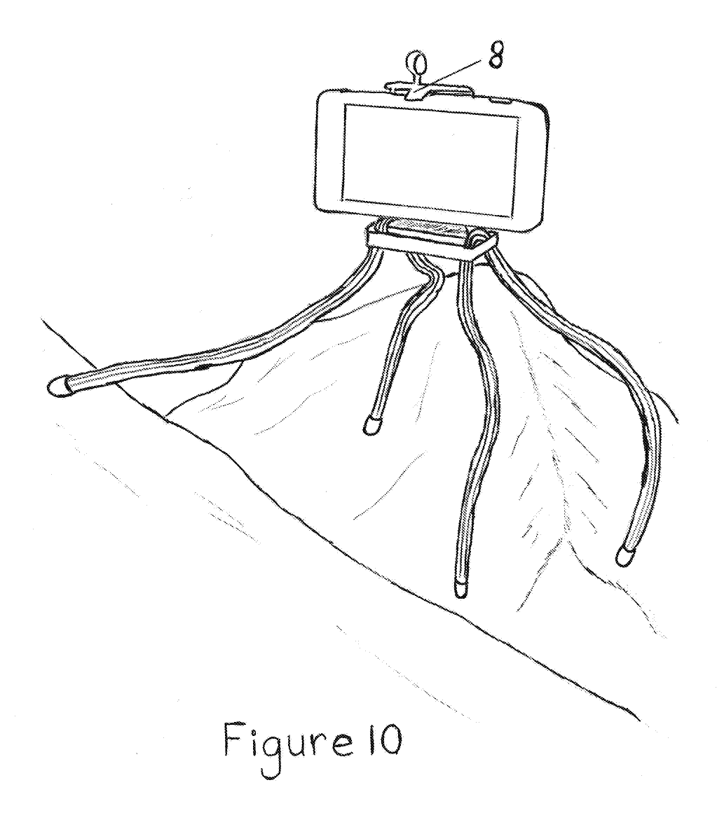

FIG. 1 shows an exploded perspective view of the various components that make up the invention. Electronic device tripod mount 1 sits atop base piece 2. Base piece 2 is a single injection molded plastic piece. A ¼′-20 thread stainless steel tripod screw 4 is inserted through center hole 7 in base piece 2 and screws into device tripod mount 1. Devices such as compact cameras, action sport cameras, and smartphones can be attached to the invention by using the appropriate type of commercially available device tripod mount. FIG. 1 shows a GoPro camera attached to the invention. Cable ties 3 are passed through the four large mounting holes 6 in base piece 2 and wrap around a desired structural member and twist together, thereby mounting the device camera to the structural member. The cable ties 3 can also be bent downward to act as a four-legged camera stand as shown in FIG. 10. Cable ties 3 utilize a shape-retaining, deformable steel alloy core and are wrapped in a soft, textured outer cover. A number of commercially available shape-retaining cable ties can be used with the present invention. Examples are Gear Ties, manufactured by Nite Ize, Silly Twists, manufactured by Silicone Zone, and several other similar cable ties manufactured in China using zinc plated Q195 steel wire. Some cable ties utilize a single wire core (Gear Ties) while others utilize a double wire core. A suction cup with self-closing slot 5 manufactured by Adams Manufacturing (part No. 7501-00-9554) can be attached to cable ties 3 by squeezing open the slot on the suction cup and attaching to the cable ties. This allows the present invention to be mounted to any flat glass surface as shown in FIG. 6.

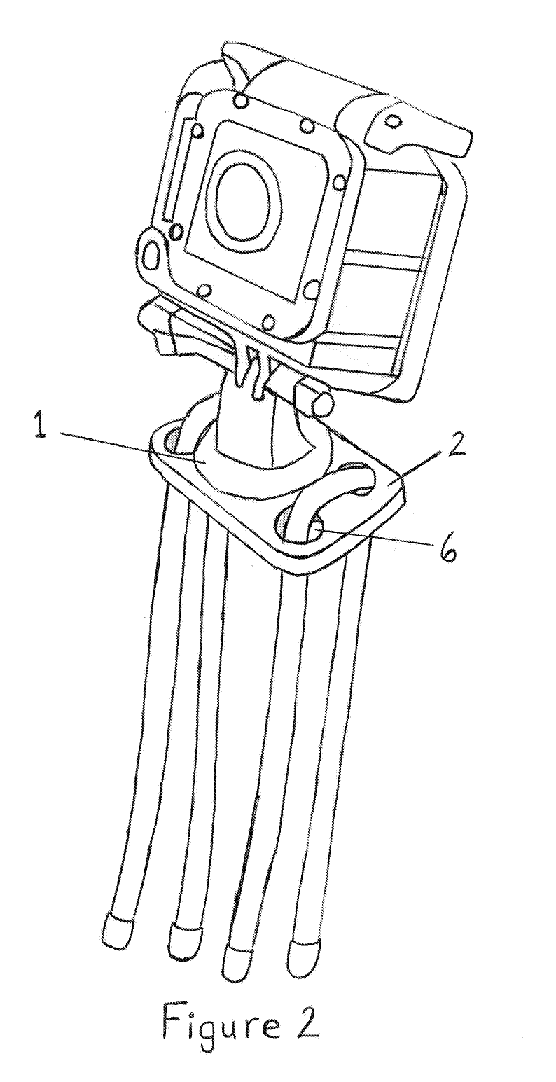

FIG. 2 is a downward looking perspective view showing the cable ties 3 passing through the four large mounting holes 6. Device tripod mount 1 sits atop base piece 2.

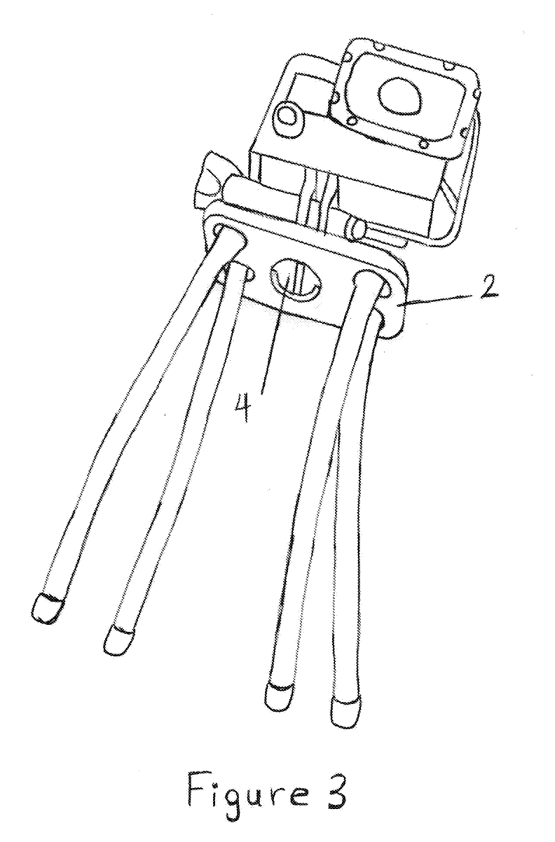

FIG. 3 is an upward looking perspective view showing stainless steel tripod screw 4 threaded through center hole 7 in base piece 2 and threaded into device tripod mount 1. Stainless steel tripod screw 4 features a moveable “D” ring that assists in tightening the screw.

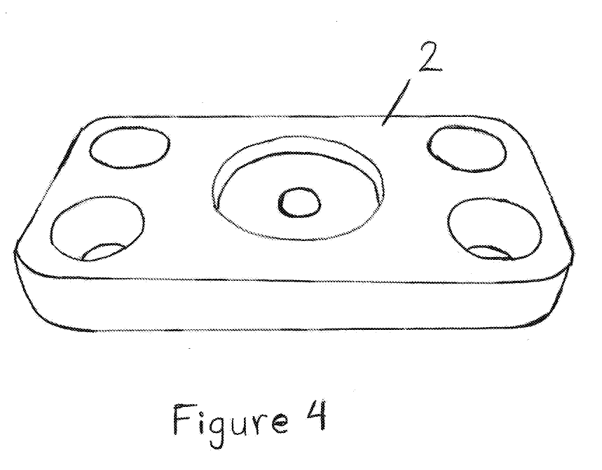

FIG. 4 is an upward looking perspective view of the base piece 2 only, showing a circular recessed area around center hole 7 which allows tripod screw 4, when installed, to sit flush with the bottom surface of base piece 2.

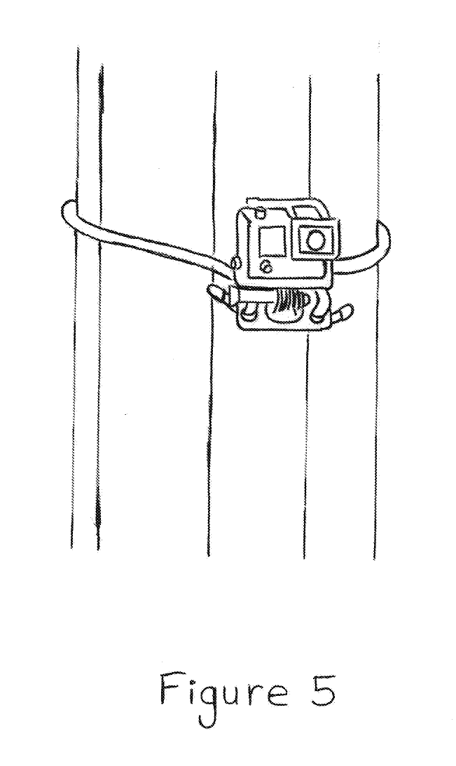

FIG. 5 shows the present invention mounted on a larger structural member, a standard street lamp post. The cable ties 3 are wrapped around the post and are twisted together at the rear, achieving a secure attachment. The cable ties can be adjusted and moved through the mounting holes 6 in the base piece to achieve a desired length.

FIG. 6 shows another embodiment of the invention mounted to a flat glass surface using the self-closing slot suction cup. One, two, three or four suction cups can be utilized to mount the invention to a flat glass, mirrored, etc. surface.

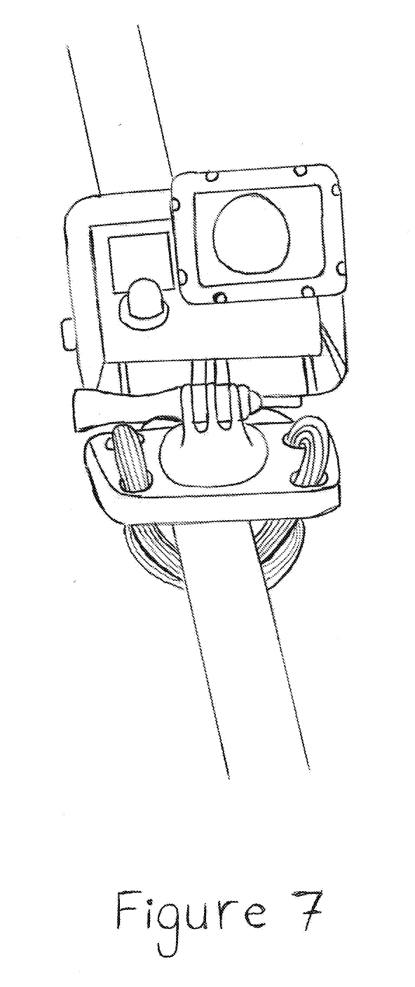

FIG. 7 shows the invention mounted to a smaller structural member, the shaft of a paddleboard paddle.

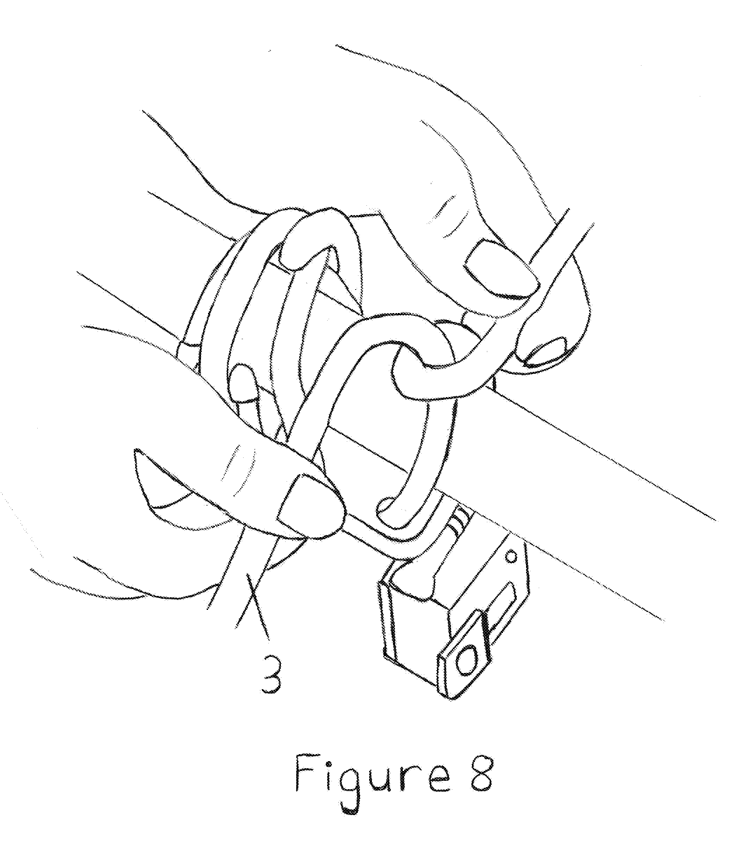

FIG. 8 show cable ties 3 being twisted around the shaft of a paddle to create a secure attachment of the invention to the paddle. Cable ties 3 are pulled tightly in opposite directions and then twisted around each other. Cable ties 3 have a soft rubber exterior that enhances the grip between the invention and surface that it mounts to.

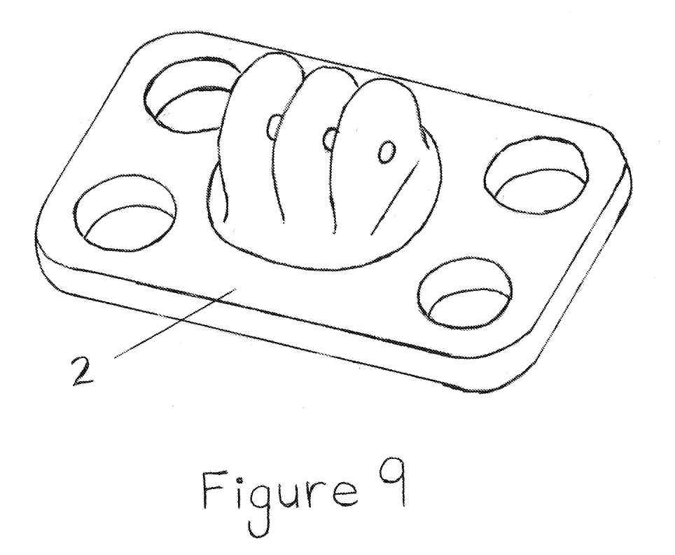

FIG. 9 shows another embodiment of the invention where a device tripod mount is integrated into the base piece. This embodiment is a single injection molded plastic piece that eliminates the need for both a separate device tripod mount 1 and a corresponding tripod screw 4.

FIG. 10 shows the invention used as a four-legged, adjustable camera stand on uneven, rocky terrain. A phone is attached to the invention using a commercially available phone mount 8 with a threaded female hole that threads on to the tripod screw. The cable ties 3 can be bent downward and adjusted to allow the invention to function as a camera stand on any horizontal surface.

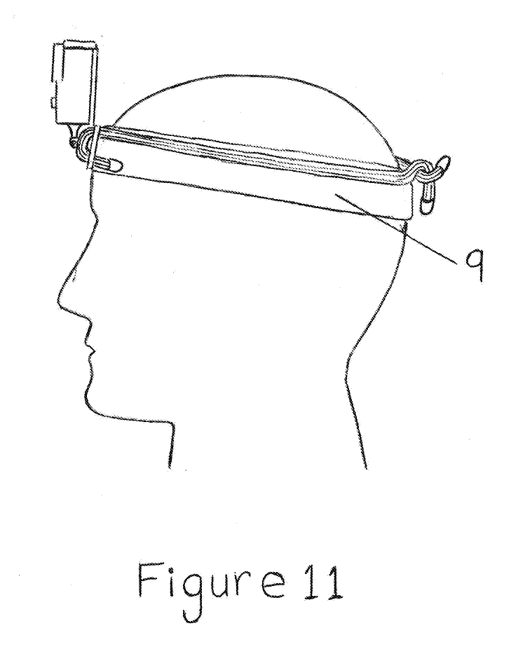

FIG. 11 shows the invention used as a head mount for hands free filming. A standard headband 9 is worn for comfort and the invention is placed on the headband with the cable ties wrapping around the head and twisting together at the back for a secure attachment.

1. A mounting apparatus featuring an array of holes that utilizes shape retaining, deformable material to connect cameras and phones to various surfaces and structures on a plurality of objects.

2. Invention in claim 1 where said invention features a center hole that accommodates a plurality of various camera and phone tripod mounting hardware.

3. Invention in claim 1 where said invention features shape retaining, deformable material in the form of commercially available, reusable cable ties.

4. Invention in claim 1 where said invention features a self-closing slotted suction cup affixed to the end of one or more cables ties to allow the mounting apparatus to mount to a vertical flat surface such as a window.
